(19) United States
(12) Patent Application Publication
(10) Pub. No.: US 2026/0322229 A1
(43) Pub. Date: Oct. 15, 2026

(54) VIBRATION MOTOR AND ELECTRONIC DEVICE

(71) Applicant: AAC Microtech (Changzhou) Co., Ltd., Changzhou City (CN)

(72) Inventors: Lubin Mao, Changzhou (CN); Yun Tang, Changzhou (CN)

(21) Appl. No.: 19/336,478

(22) Filed: Sep. 22, 2025

Related U.S. Application Data
(63) Continuation of application No. PCT/CN2025/088027, filed on Apr. 9, 2025.

(51) Int. Cl. H02K 33/02; H02K 1/14; H02K 33/18

(52) U.S. Cl. CPC H02K 33/02; H02K 1/14; H02K 33/18

(57) ABSTRACT

A vibration motor and an electronic device are provided. The vibration motor includes a housing with a first accommodating chamber, a stator solenoid accommodated in the first accommodating chamber and fixed to the housing, a vibrator suspended inside the first accommodating chamber, and an elastic connector connected to the vibrator and the housing, the vibrator includes a mass block and a magnetic circuit assembly fixed to the mass block. The vibrator vibrates in a first vibration direction and a second vibration direction perpendicular to the first vibration direction. The magnetic circuit assembly is obliquely magnetized. The vibration motor of the present invention can implement bidirectional vibration in a first vibration direction and a second vibration direction of the vibration motor, while ensuring that an overall stress of the elastic connector meets a reliability requirement and the rigidity design is simple.

### CROSS-REFERENCE TO RELATED APPLICATIONS

This application is a continuation of International Application No. PCT/CN2025/088027, filed on Apr. 9, 2025, the entire content of which is incorporated herein by reference.

### TECHNICAL FIELD

The present invention relates to the technical field of motors, and in particular to, a vibration motor and an electronic device.

### BACKGROUND

A vibration motor is one of important components of electronic device, and is usually used for system feedback of the electronic device, such as an incoming call alert of a mobile phone, message alert, a navigation prompt, and vibration feedback of a game console. However, the vibration motor in the prior art generally only receives a driving force in a single direction. As a result, the vibration motor can only generate vibration sensation in a single direction.

Therefore, it is necessary to provide a vibration motor with multidirectional vibration modes, and an electronic device.

### SUMMARY

The present invention aims to provide a vibration motor and an electronic device. The vibration motor has a multidirectional vibration mode and can implement bidirectional vibration in a first vibration direction and a second vibration direction.

The technical solution of the present invention is as follows:

In the first aspect, The present invention provides a vibration motor, including a housing with a first accommodating chamber, a stator solenoid accommodated in the first accommodating chamber and fixed to the housing, a vibrator suspended inside the first accommodating chamber, and an elastic connector connected to the vibrator and the housing, and the vibrator includes a mass block and a magnetic circuit assembly fixed to the mass block; the vibrator vibrates in a first vibration direction and a second vibration direction perpendicular to the first vibration direction; the magnetic circuit assembly is obliquely magnetized, and has a magnetization direction parallel to an XZ plane; the elastic connector includes a first elastic connector and a second elastic connector that are connected to each other; the first elastic connector extends in the first vibration direction and is fixed to the mass block; the second elastic connector extends in the second vibration direction and is fixed to an inner wall of the housing; and the XZ plane is a plane parallel to a plane enclosed by the first vibration direction and the second vibration direction.

Optionally, the vibrator also includes the mass block is of a hollow structure having a second accommodating chamber which suspended inside the first accommodating chamber; the mass block includes two opposite X-directional end surfaces perpendicular to the first vibration direction, and two opposite Z-directional end surfaces perpendicular to the second vibration direction; two first elastic connectors are included, which are respectively connected to the two Z-directional end surfaces; two second elastic connectors are included, which are respectively spaced apart from the two X-directional end surfaces; and each first elastic connector is connected in series with the two second elastic connectors.

Optionally, the first connecting blocks that protrude and extend away from the mass block and are respectively connected to the two first elastic connectors are arranged on the two Z-directional end surfaces; and second connecting blocks connected to the second elastic connectors are arranged on inner walls of the housing opposite to the two second elastic connectors.

Optionally, the two first elastic connectors include first fixed portions fixedly connected to the first connecting blocks and first deformation portions symmetrically connected to two ends of the first fixed portions in an X direction; the two second elastic connectors include second fixed portions fixedly connected to the second connecting blocks and second deformation portions symmetrically connected to two ends of the second fixed portions in a Z direction.

Optionally, the Kx of the first elastic connector is greater than Kz, and Kz of the second elastic connector is greater than Kx, wherein Kx is an elastic coefficient component of the elastic connector in the first vibration direction, and Kz is an elastic coefficient component of the elastic connector in the second vibration direction.

Optionally, the magnetic circuit assembly includes a first pole core and a second pole core that are parallel to the XZ plane and are respectively fixed to two opposite inner walls of the mass block, a first magnet fixed to the first pole core, and a second magnet that is fixed to the second pole core and directly faces the first magnet; and polarities of magnetic poles, directly facing each other, of the first magnet and the second magnet are the same.

Optionally, the stator solenoid includes an iron core, two magnetic conductive pole shoes respectively fixedly arranged at two ends of the iron core, and a coil wound around a surface of the iron core and located between the two magnetic conductive pole shoes; and the two magnetic conductive pole shoes are fixed to a bottom wall of the housing and are respectively spaced apart from and opposite to the first magnet and the second magnet.

Optionally, the first elastic connector and the second elastic connector are flat springs.

Optionally, the elastic connector is obtained by assembling and connecting the first elastic connector and the second elastic connector after the first elastic connector and the second elastic connector are separately formed.

In another aspect, the present invention provides an electronic device, Including the vibration motor as described in any of the preceding items.

Beneficial effects of the present invention are as follows.

The present invention provides a vibration motor and an electronic device. The vibration motor includes the elastic connector respectively connected to the vibrator and the housing. The elastic connector includes the first elastic connector and the second elastic connector that are connected to each other. The first elastic connector and the second elastic connector are respectively arranged in the first vibration direction and the second vibration direction and are connected in series to each other. The first elastic connector and the second elastic connector are respectively connected to the mass block and the housing, which provides a structural basis for the bidirectional vibration mode of the vibration motor in the first vibration direction and the second vibration direction while ensuring that an overall stress of the elastic connector meets a reliability requirement and the rigidity design is simple. The vibrator includes two sections of magnets magnetized obliquely. The magnets can provide the vibrator with vibration driving forces in the first vibration direction and the second vibration direction, thereby providing a power basis for the vibration motor to implement bidirectional vibration in the first vibration direction and the second vibration direction, so that a vibration function of the vibration motor in the first vibration direction and the second vibration direction is achieved, and a hardware basis is provided for the vibration motor to use the diversity of a vibration signal.

### BRIEF DESCRIPTION OF THE DRAWINGS

FIG. 1 is an exploded view of a vibration motor according to the present invention.

FIG. 2 is a top view of a vibration motor according to the present invention.

FIG. 3 is a cross-sectional view of FIG. 2 along A-A.

FIG. 4 is a cross-sectional view of FIG. 2 along B-B.

FIG. 5 is a schematic diagram of magnetic distribution of magnetization of a magnet in a magnetic circuit assembly.

FIG. 6 is a schematic diagram of assembling of an elastic connector.

FIG. 7 is a schematic diagram of assembling of an elastic connector and a vibrator.

FIG. 8 is a schematic structural diagram of an elastic connector.

### DETAILED DESCRIPTION OF THE EMBODIMENTS

The present invention is further described below in detail in combination with the accompanying drawings and embodiments.

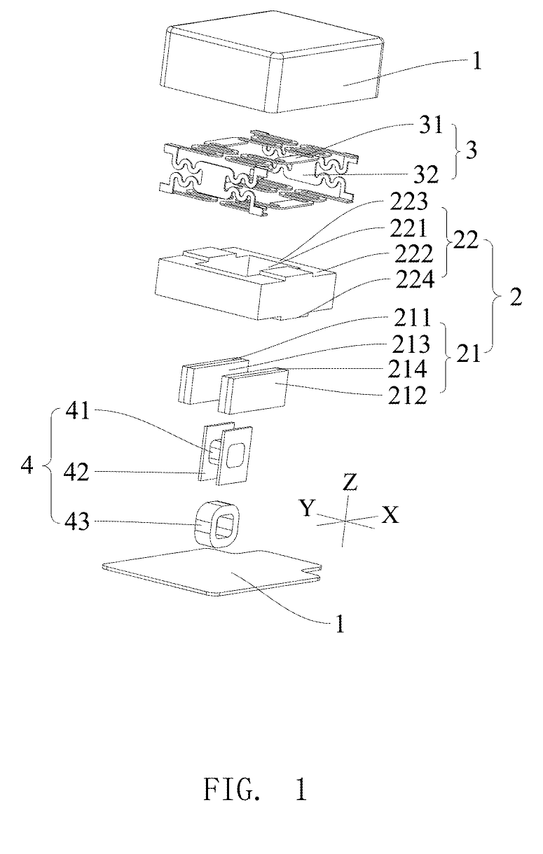

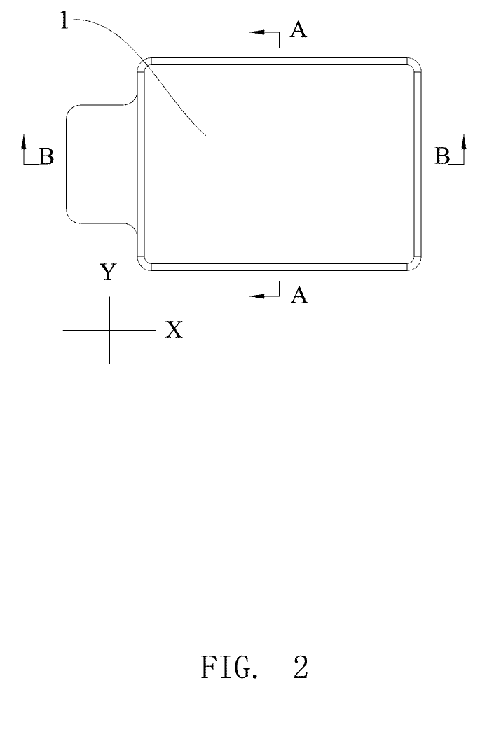

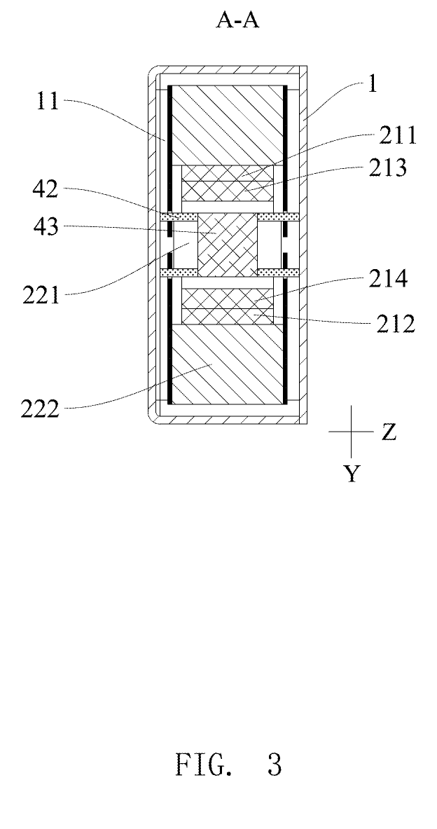

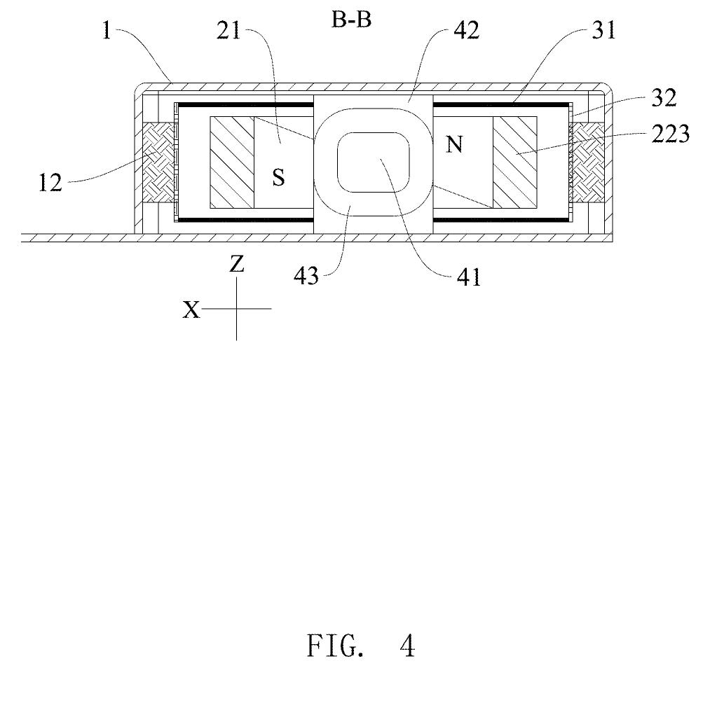

The present invention provides a vibration motor. Referring to FIGS. 1 to 6, the vibration motor includes a housing 1 with a first accommodating chamber 11, a stator solenoid 4 accommodated in the first accommodating chamber 11 and fixed to the housing 1, a vibrator 2 suspended inside the first accommodating chamber 11, and an elastic connector 3 connected to the vibrator 2 and the housing 1. The vibrator 2 includes a mass block 22 and a magnetic circuit assembly 21 fixed to the mass block 22. The vibrator 2 vibrates in a first vibration direction X and a second vibration direction Z perpendicular to the first vibration direction X. The magnetic circuit assembly 21 is obliquely magnetized, and has a magnetization direction parallel to an XZ plane. The elastic connector 3 includes a first elastic connector 31 and a second elastic connector 32 that are connected to each other. The first elastic connector 31 extends in the first vibration direction X and is fixed to the mass block 22. The second elastic connector 32 extends in the second vibration direction Z and is fixed to an inner wall of the housing 1. The XZ plane is a plane parallel to a plane enclosed by the first vibration direction X and the second vibration direction Z.

It should be noted that the first vibration direction in the present invention is a direction parallel to an X direction in a space coordinate system, and the second vibration direction is a direction parallel to a Z direction in the space coordinate system. An inside direction is a direction close to a center of the housing 1, while an outside direction is a direction away from the center of the housing 1. The corresponding XZ plane is a plane parallel to a plane enclosed by an X axis and a Z axis in the space coordinate system.

The vibration motor of the present invention includes the elastic connector 3 respectively connected to the vibrator 2 and the housing 1. The elastic connector 3 includes the first elastic connector 31 and the second elastic connector 32 that are connected to each other. The first elastic connector 31 and the second elastic connector 32 are respectively arranged in the first vibration direction X and the second vibration direction Z and are connected in series to each other. The first elastic connector 31 and the second elastic connector 32 are respectively connected to the mass block 22 and the housing 1, which provides a structural basis for the bidirectional vibration mode of the vibration motor in the first vibration direction X and the second vibration direction Z while ensuring that an overall stress of the elastic connector 3 meets a reliability requirement and the rigidity design is simple. The magnetic circuit assembly is obliquely magnetized and has the magnetization direction parallel to the XZ plane. The magnetic circuit assembly can provide the vibrator 2 with vibration driving forces in the first vibration direction X and the second vibration direction Z, thereby providing a basis for the vibration motor to implement bidirectional vibration in the first vibration direction X and the second vibration direction Z, so that a vibration function of the vibration motor in the first vibration direction X and the second vibration direction Z is achieved, and a hardware basis is provided for the vibration motor to use the diversity of a vibration signal.

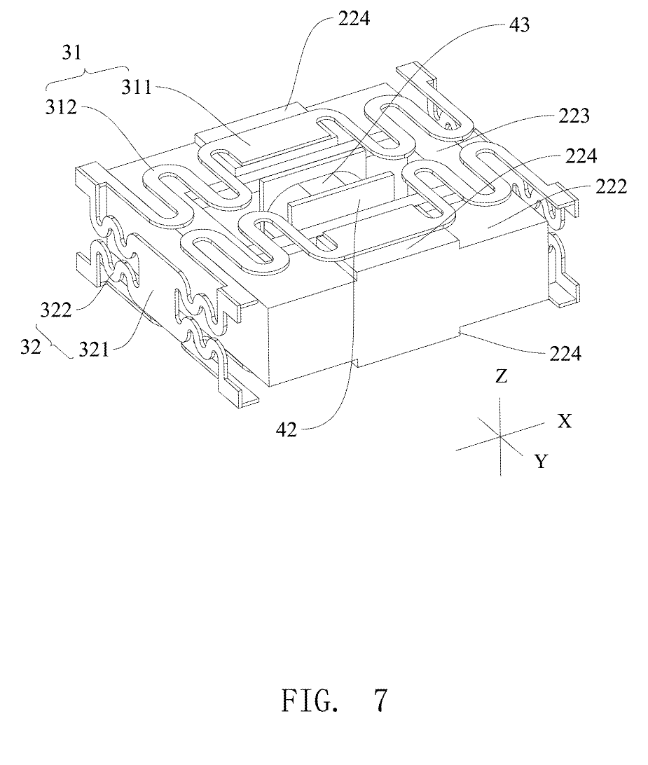

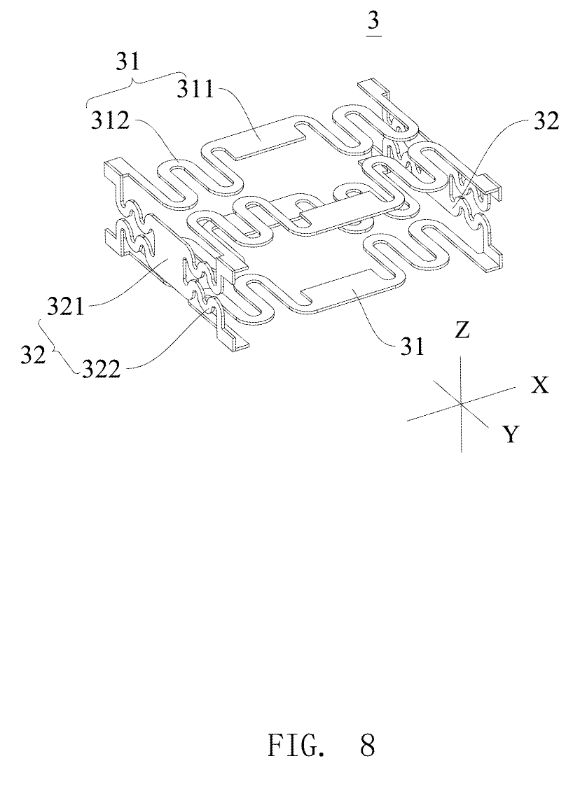

Referring to FIGS. 1 and 6 to 8, the mass block 22 is of a hollow structure having a second accommodating chamber 221. The mass block 22 includes two opposite X-directional end surfaces 223 perpendicular to the first vibration direction X, and two opposite Z-directional end surfaces 222 perpendicular to the second vibration direction Z. Two first elastic connectors 31 are included, which are respectively connected to the two Z-directional end surfaces 222. Two second elastic connectors 32 are included, which are respectively spaced apart from the two X-directional end surfaces 223. Each first elastic connector 31 is connected in series with the two second elastic connectors 32.

First connecting blocks 224 that protrude and extend away from the mass block 22 and are respectively connected to the two first elastic connectors 31 are arranged on the two Z-directional end surfaces 222; and second connecting blocks 12 connected to the second elastic connectors 32 are arranged on inner walls of the housing 1 opposite to the two second elastic connectors 32.

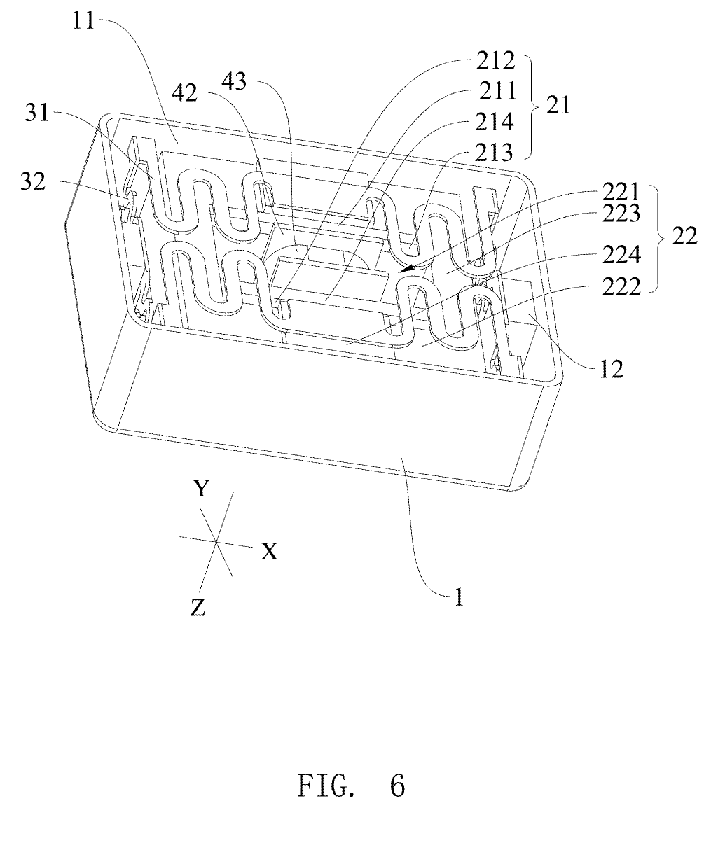

Referring to FIGS. 6 to 8, the two first elastic connectors 31 include first fixed portions 311 fixedly connected to the first connecting blocks 224 and first deformation portions 312 symmetrically connected to two ends of the first fixed portions 311 in an X direction; the two second elastic connectors 32 include second fixed portions 321 fixedly connected to the second connecting blocks 12 and second deformation portions 322 symmetrically connected to two ends of the second fixed portions 321 in a Z direction.

Optionally, Kx of the first elastic connector 31 is greater than Kz, and Kz of the second elastic connector 32 is greater than Kx, where Kx is an elastic coefficient component of the elastic connector 3 in the first vibration direction X, and Kz is an elastic coefficient component of the elastic connector 3 in the second vibration direction Z. That is, when the vibrator 2 operates in the X direction, deformation mainly occurs in the second elastic connector 32. When the oscillator 2 operates in the second vibration direction Z, deformation mainly occurs in the first elastic connector 31. According to actual needs, setting values of Kx and Kz of the first elastic connector 31 and the second elastic connector 32 can set values of Fx and Fz of the vibration motor, and further ensures that the overall stress of the elastic connector 3 meets the reliability requirement and the rigidity design is simple, where Fx is a vibration force of the vibration motor in the first vibration direction X, and Fz is a vibration force of the vibration motor in the second vibration direction Z.

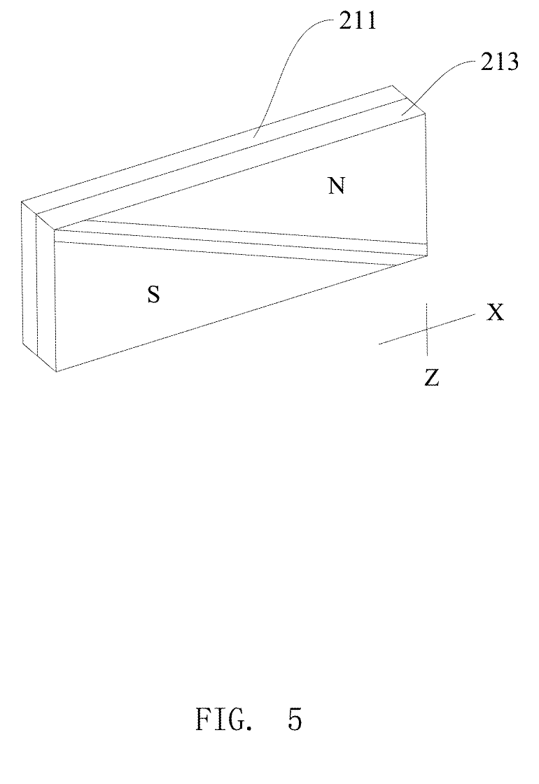

Referring to FIGS. 1 to 4, the magnetic circuit assembly 21 includes a first pole core 211 and a second pole core 212 that are parallel to the XZ plane and are respectively fixed to two opposite inner walls of the mass block 22, a first magnet 213 fixed to the first pole core 211, and a second magnet 214 that is fixed to the second pole core 212 and directly faces the first magnet 213. Referring to FIG. 5, the first magnet 213 is used as an example. The magnetic distribution of magnetization of the magnets in the present invention will be specifically shown. Polarities of magnetic poles, directly facing each other, of the first magnet 213 and the second magnet 214 are the same.

Referring to FIGS. 1 to 4 and 6, the stator solenoid 4 includes an iron core 41, two magnetic conductive pole shoes 42 respectively fixedly arranged at two ends of the iron core 41, and a coil 43 wound around a surface of the iron core 41 and located between the two magnetic conductive pole shoes 42. The two magnetic conductive pole shoes 42 are fixed to a bottom wall of the housing 1 and are respectively spaced apart from and opposite to the first magnet 213 and the second magnet 214. After the stator solenoid 4 is powered on, the two magnetic conductive pole shoes 42 are magnetized, thereby possessing magnetic attraction.

The first magnet 213 and the second magnet 214 are adhered to an inner wall of the mass block 22, and the polarities of the magnetic poles, directly facing each other, of the first magnet 213 and the second magnet 214 are the same. Specifically, the mass block 22 is arranged at a periphery of the magnetic circuit assembly 21, and the first magnet 213 and the second magnet 214 are respectively fixedly arranged on the inner wall of the mass block 22.

Optionally, in the embodiments of the present invention, both the first elastic connector 31 and the second elastic connector 32 are flat springs. The present invention does not impose specific limitations on shapes of the first elastic connector 31 and the second elastic connector 32. It can be understood that in some other embodiments, the elastic connector 3 can employ other structural forms besides a flat spring structure. It should be noted that up and down directions are two planes that are opposite to each other in the second vibration direction Z.

Optionally, in some embodiments, the elastic connector 3 is obtained by assembling and connecting the first elastic connector 31 and the second elastic connector 32 after the first elastic connector 31 and the second elastic connector 32 are separately formed. The first elastic connector 31 and the second elastic connector 32 are combined and assembled after being separately formed, which facilitates the connection between the elastic connector 3 and the housing 1, as well as the vibrator 2.

In some other embodiments, the elastic connector 3 is integrally formed by the first elastic connector 31 and the second elastic connector 32, thereby directly mounting the elastic connector 3 after the elastic connector 3 is formed once, which eliminates assembling of the elastic connector 3. In addition, the integrated structure ensures firmness and stability of the connection between the first elastic connector 31 and the second elastic connector 32.

The embodiments in the present invention also provide an electronic device, which includes the vibration motor as described above. the vibration motor has a vibration function in the first vibration direction X and the second vibration direction Z, and a hardware basis is provided for the vibration motor to use the diversity of a vibration signal.

The above is only the preferred embodiments of the present invention, it should be noted that those of ordinary skill in the art can further make improvements without departing from the concept of the present invention. These improvements shall all fall within the protection scope of the present invention.

What is claimed is:

1. A vibration motor, comprising a housing with a first accommodating chamber, a stator solenoid accommodated in the first accommodating chamber and fixed to the housing, a vibrator suspended inside the first accommodating chamber, and an elastic connector connected to the vibrator and the housing, wherein the vibrator comprises a mass block and a magnetic circuit assembly fixed to the mass block; the vibrator vibrates in a first vibration direction and a second vibration direction perpendicular to the first vibration direction; the magnetic circuit assembly is obliquely magnetized, and has a magnetization direction parallel to an XZ plane; the elastic connector comprises a first elastic connector and a second elastic connector that are connected to each other; the first elastic connector extends in the first vibration direction and is fixed to the mass block; the second elastic connector extends in the second vibration direction and is fixed to an inner wall of the housing; and the XZ plane is a plane parallel to a plane enclosed by the first vibration direction and the second vibration direction.

2. The vibration motor according to claim 1, wherein the mass block is of a hollow structure having a second accommodating chamber; the mass block comprises two opposite X-directional end surfaces perpendicular to the first vibration direction, and two opposite Z-directional end surfaces perpendicular to the second vibration direction; two first elastic connectors are comprised, which are respectively connected to the two Z-directional end surfaces; two second elastic connectors are comprised, which are respectively spaced apart from the two X-directional end surfaces; and each first elastic connector is connected in series with the two second elastic connectors.

3. The vibration motor according to claim 2, wherein first connecting blocks that protrude and extend away from the mass block and are respectively connected to the two first elastic connectors are arranged on the two Z-directional end surfaces; and second connecting blocks connected to the second elastic connectors are arranged on inner walls of the housing opposite to the two second elastic connectors.

4. The vibration motor according to claim 3, wherein the two first elastic connectors comprise first fixed portions fixedly connected to the first connecting blocks and first deformation portions symmetrically connected to two ends of the first fixed portions in an X direction; the two second elastic connectors comprise second fixed portions fixedly connected to the second connecting blocks and second deformation portions symmetrically connected to two ends of the second fixed portions in a Z direction.

5. The vibration motor according to claim 1, wherein Kx of the first elastic connector is greater than Kz, and Kz of the second elastic connector is greater than Kx, wherein Kx is an elastic coefficient component of the elastic connector in the first vibration direction, and Kz is an elastic coefficient component of the elastic connector in the second vibration direction.

6. The vibration motor according to claim 1, wherein the magnetic circuit assembly comprises a first pole core and a second pole core that are parallel to the XZ plane and are respectively fixed to two opposite inner walls of the mass block, a first magnet fixed to the first pole core, and a second magnet that is fixed to the second pole core and directly faces the first magnet; and polarities of magnetic poles, directly facing each other, of the first magnet and the second magnet are the same.

7. The vibration motor according to claim 6, wherein the stator solenoid comprises an iron core, two magnetic conductive pole shoes respectively fixedly arranged at two ends of the iron core, and a coil wound around a surface of the iron core and located between the two magnetic conductive pole shoes; and the two magnetic conductive pole shoes are fixed to a bottom wall of the housing and are respectively spaced apart from and opposite to the first magnet and the second magnet.

8. The vibration motor according to claim 1, wherein the first elastic connector and the second elastic connector are flat springs.

9. The vibration motor as claimed in claim 1, wherein the elastic connector is obtained by assembling and connecting the first elastic connector and the second elastic connector after the first elastic connector and the second elastic connector are separately formed.

10. An electronic device, comprising the vibration motor according to claim 1.
